(19) United States
(12) Patent Application Publication
(10) Pub. No.: US 2014/0373693 A1
(43) Pub. Date: Dec. 25, 2014

(54) Cutting Blade with Regenerating Edge Segments

(71) Applicants: Saint-Gobain Abrasives, Inc., Worcester, MA (US); Saint-Gobain Abrasifs, Conflans-Sainte-Honorine (FR)

(72) Inventor: Ignazio Gosamo, Leglise-Thibessart (BE)

(73) Assignees: Saint-Gobain Abrasives, Inc., Worcester, MA (US); Saint-Gobain Abrasifs, Conflans-Sainte-Honorine (FR)

(21) Appl. No.: 14/280,124

(22) Filed: May 16, 2014

Related U.S. Application Data
(60) Provisional application No. 61/839,117, filed on Jun. 25, 2013.

(51) Int. Cl. B24D 5/12; B23D 61/02

(52) U.S. Cl. CPC B24D 5/123; B23D 61/02
USPC 83/39; 451/542

(57) ABSTRACT

An abrasive article includes a blade body having an axis of rotation, and a peripheral edge comprising a plurality of blade segments with perimeter edges. Adjacent ones of the blade segments may be separated from each other by a slot that extends into the blade body at least partially in a radial direction with respect to the axis. At least one blade segment may include a plurality of apertures extending axially therethrough, comprising a perimeter edge aperture that intersects the perimeter edge, and at least two interior apertures are radially offset from and do not intersect the perimeter edge. An abrasive portion may include a bond material and abrasive particles, the abrasive portion overlies at least portions of the blade segments.

### CROSS-REFERENCE TO RELATED APPLICATION(S)

This application claims priority to and the benefit of U.S. Prov. App. No. 61/839,117, filed Jun. 25, 2013, and is incorporated herein by reference in its entirety.

### BACKGROUND

1. Field of the Disclosure

The following is generally directed to construction blades and processes for forming the same, and more particularly, to blades utilizing blade segments having regenerating blade edges.

2. Description of the Related Art

Tools necessary for furthering infrastructure improvements, such as building additional roads and buildings, are vital to the continued economic expansion of developing regions. Additionally, developed regions have a continuing need to replacing aging infrastructure with new and expanded roads and buildings.

The construction industry utilizes a variety of tools for cutting and grinding of construction materials. Cutting and grinding tools are required for to remove or refinish old sections of roads. Additionally, quarrying and preparing finishing materials, such as stone slabs used for floors and building facades, require tools for drilling, cutting, and polishing. Typically, these tools include cutting segments that extend from a base element or core, such as a plate or a wheel. As with other industries, improvements to these cutting tools continue to be of interest.

### SUMMARY

According to a first aspect, an abrasive article includes a blade body having an axis of rotation, and a peripheral edge comprising a plurality of blade segments with perimeter edges. Adjacent ones of the blade segments may be separated from each other by a slot that extends into the blade body at least partially in a radial direction with respect to the axis. At least one blade segment may include a plurality of apertures extending axially therethrough, comprising a perimeter edge aperture that intersects the perimeter edge, and at least two interior apertures are radially offset from and do not intersect the perimeter edge. An abrasive portion may include a bond material and abrasive particles, and the abrasive portion overlies at least portions of the blade segments.

In another aspect, an abrasive article can include a blade body having an axis of rotation, and a peripheral edge comprising a plurality of blade segments. Adjacent ones of the blade segments can be separated from each other by a slot that extends into the blade body at least partially in a radial direction with respect to the axis. At least one of the blade segments can include a radial edge aperture extending axially therethrough. The radial edge aperture can intersect a radial edge of the at least one of the blade segments, such that the radial edge aperture intersects a respective slot in the blade body. An abrasive portion can include a bond material and abrasive particles, and the abrasive portion overlies at least portions of the blade segments.

In still another aspect, a method of using a rotary cutting blade can include providing a blade body with a plurality of blade segments, a cutting profile having apertures in each blade segment at a radially outermost portion thereof, and a secondary profile having apertures located radially inward of the cutting profile in respective interiors of the blade segments. The method can include using the rotary cutting blade to cut a workpiece with the cutting profiles. The method can further include wearing the cutting profiles such they are worn and eroded; exposing the secondary profiles such that they are the radially outermost portion of the blade segments; and then using the rotary cutting blade to cut the workpiece with the secondary profiles.

The foregoing and other objects and advantages of these embodiments will be apparent to those of ordinary skill in the art in view of the following detailed description, taken in conjunction with the appended claims and the accompanying drawings.

### BRIEF DESCRIPTION OF THE DRAWINGS

The present disclosure may be better understood, and its numerous features and advantages made apparent to those skilled in the art by referencing the accompanying drawings.

FIG. 1 includes a plan view of an embodiment of an abrasive article.

FIG. 2 includes an enlarged plan view of an embodiment of a blade segment of an abrasive article.

FIGS. 3-5 include enlarged plan views of other embodiments of a blade segment of an abrasive article.

FIGS. 6A-6F include enlarged plan views of still other embodiments of a blade segment of an abrasive article, both before and after use.

FIG. 7 includes an enlarged plan view of yet another embodiment of a blade segment of an abrasive article.

The use of the same reference symbols in different drawings indicates similar or identical items.

### DETAILED DESCRIPTION

According to an embodiment, the abrasive article herein can include cutting tools utilizing segments having regenerating blade edges. The abrasive articles of the embodiments herein may be used to remove material from various workpieces by relative movement of the abrasive article relative to the workpiece. The abrasive article can be a grinding tool for grinding metal, concrete, or natural stone. The abrasive articles of embodiments herein can be a cutting tool for cutting construction materials, such as a saw for cutting concrete.

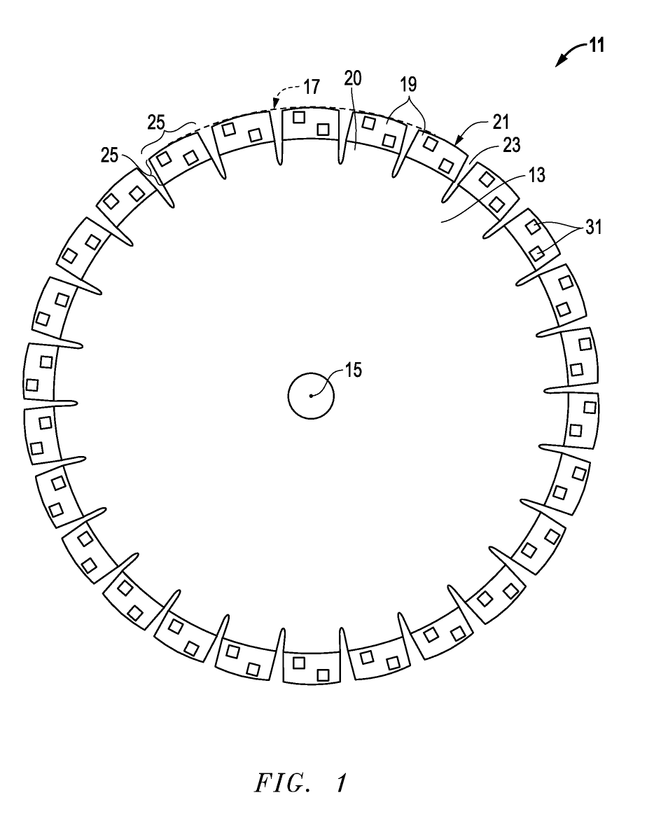

Embodiments of an abrasive article 11 (FIG. 1) may comprise a blade body 13 having an axis 15 of rotation. For example, the abrasive article 11 may comprise a grinding wheel or a blade, and the blade body 13 may comprise a steel plate.

The blade body 13 also may include a peripheral edge 17 (see dashed line in FIG. 1) comprising a plurality of blade segments 19. Each blade segment 19 may include a perimeter edge 21. Adjacent ones of the blade segments 19 may be separated from each other by a slot 23 that extends into the blade body 13 at least partially in a radial direction with respect to the axis 15.

Embodiments of the abrasive article 11 may further comprise an abrasive portion 25. The abrasive portion 25 may comprise a bond material and abrasive particles. For example, the bond material may include a metallic powder, and the abrasive particles may include diamond. The abrasive portion 25 may overlay at least portions of the blade segments 19. For example, the abrasive portion 25 may be located only on the outer radial tips of the blade segments 19, as shown. In some examples, the inner radial portions 20 of blade segments 19 do not comprise the abrasive portion 25. In some versions, the abrasive portion 25 may overlay all of the blade segments 19. In other versions, the abrasive portion 25 may be located exclusively on the blade segments 19, and not on any other portion of the blade body 13, such that the abrasive portion 25 comprises a plurality of discontinuous abrasive portions 25 that are circumferentially spaced apart from other on the blade segments 19.

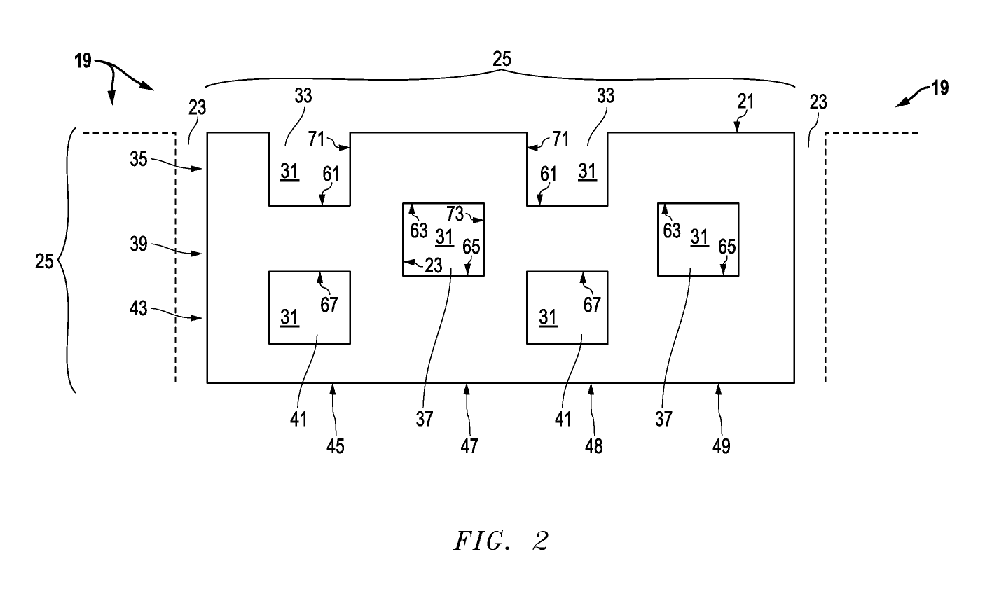

Embodiments of the at least one blade segment 19 may comprises a plurality of apertures 31 extending axially therethrough. As shown in FIG. 2, the apertures 31 may include one or more perimeter edge apertures 33 (e.g., in a circumferential row 35) that intersect the perimeter edge 21. The perimeter edge apertures 33 intersect the perimeter edge 21 in the sense that they are radially open or exposed to the exterior of abrasive article 11. In some versions, all of the blade segments 19 may include at least one perimeter edge aperture 33.

The apertures 31 may further include at least two interior apertures 37 (e.g., a second circumferential row 39). The interior apertures 37 may be radially offset from and may not intersect the perimeter edge 21 or perimeter edge apertures 33. Versions of the interior apertures 37 may not intersect the perimeter edge 21 in the sense that (at least initially, before use) they are closed or not radially open to the exterior of the abrasive article 11.

Embodiments of the apertures 31 may further include at least one additional interior aperture 41 (e.g., a third circumferential row 43). Interior aperture 41 may be radially offset from (e.g., inwardly) and may not intersect the at least two interior apertures 37. Versions of the interior apertures 37 may not intersect the perimeter edge 21 in the sense that (at least initially, before use) they are closed or not radially open to the exterior of the abrasive article 11.

In other examples, all of the blade segments 19 may comprise perimeter edge apertures 33 and at least two interior apertures 35. Thus, the plurality of apertures 31 may comprise a plurality of circumferential rows 35, 39, 43. In some versions, at least one of the circumferential rows 35, 39, 43 has at least two apertures 31. In still other embodiments, the plurality of apertures 31 may comprise a plurality of radial columns 45, 47 49. In some versions, at least one of the radial columns 45, 47, 49 has at least two apertures 31.

Further examples of the plurality of apertures 31 may comprise a checkerboard pattern (e.g., FIG. 2) having a plurality of circumferential rows 35, 39, 43, and/or a plurality of radial columns 45, 47, 48, 49. In other versions, the plurality of apertures 31 may be formed in an array about the axis of rotation 15 (FIG. 1). The array may be symmetrical, asymmetrical, patterned, irregular or may comprise a plurality of arrays.

In some embodiments, the various rows and columns may be evenly or unevenly arrayed. The rows and columns may align or they may overlap radially or circumferentially. For example, as shown in FIG. 2, the lower edges 61 of perimeter edge apertures 33 may be radially closer to axis 15 (FIG. 1) than the upper edges 63 of interior apertures 37. However, their respective edges 61, 63 may radially align or be radially spaced further apart from each other. Likewise, the lower edges 65 of interior apertures 37 may be radially closer to axis 15 than the upper edges 67 of interior apertures 41. And similarly, their respective edges 65, 67 may radially align or be radially spaced further apart from each other. Other embodiments may include combinations of these features such that the apertures form an irregular or asymmetrical array.

In FIG. 2, the apertures 31 also are illustrated as being circumferentially spaced apart such that their adjacent circumferential edges 71, 73 are circumferentially spaced apart. However, the adjacent circumferential edges 71, 73 of the apertures 31 could be circumferentially closer, align, or even overlap.

In some examples, the abrasive portion 25 may be mounted to the blade body 13 by one or more of adhesive bonding, brazing, laser welding and attachment by infiltration. For example, attachment methods for joining the abrasive portion 25 to the blade body are disclosed in U.S. 2010/0035530, which is incorporated herein by reference in its entirety.

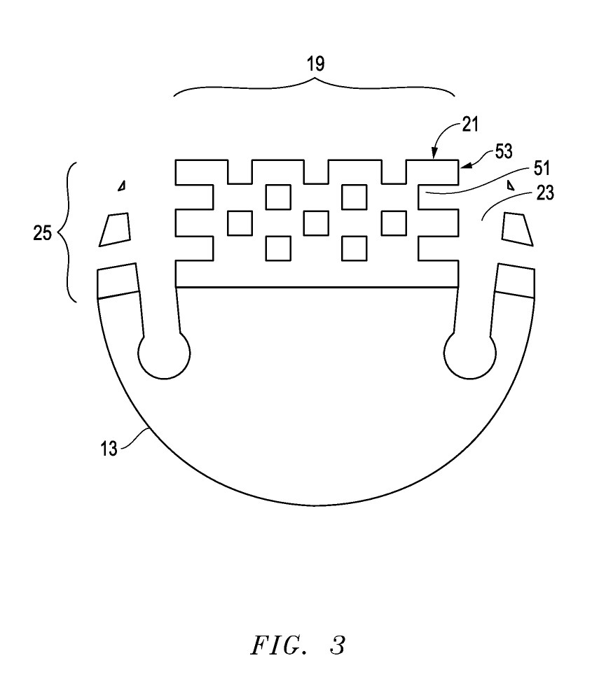

Embodiments of the abrasive article 11 may include at least one radial edge aperture 51 (FIG. 3). Radial edge aperture 51 may be formed in a radial edge 53 of at least one of the blade segments 19. The radial edge aperture 51 may intersect a respective slot 23 in the blade body 13. The radial edge aperture 51 intersects the slot 23 in the sense that it is circumferentially open or exposed to the open slot 23, which in turn is open and extends to the exterior of abrasive article 11. In another example, the radial edge aperture 51 may be radially offset from the perimeter edge 21, such that it does not intersect the perimeter edge 21 of the at least one of the blade segments 19.

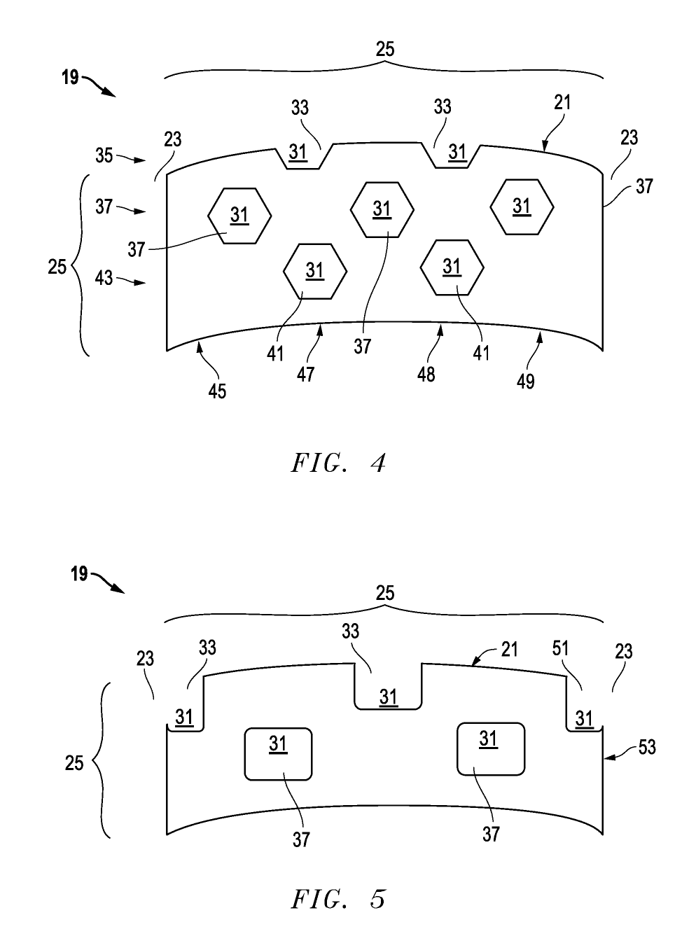

Although FIGS. 2 and 3 depict the plurality of apertures 31 as generally rectangular, the apertures 31 may comprise a variety of shapes. For example, the apertures may comprise other shapes such as those depicted in FIGS. 4-7. Possible shapes for apertures 31 include but are not limited to one or more of polygons, curvilinear shapes or a combination thereof, such as triangles, rectangles, squares, trapezoids, pentagons, hexagons, circles, ellipses, ovals, letters, sharp corners, rounded corners, and any combination thereof.

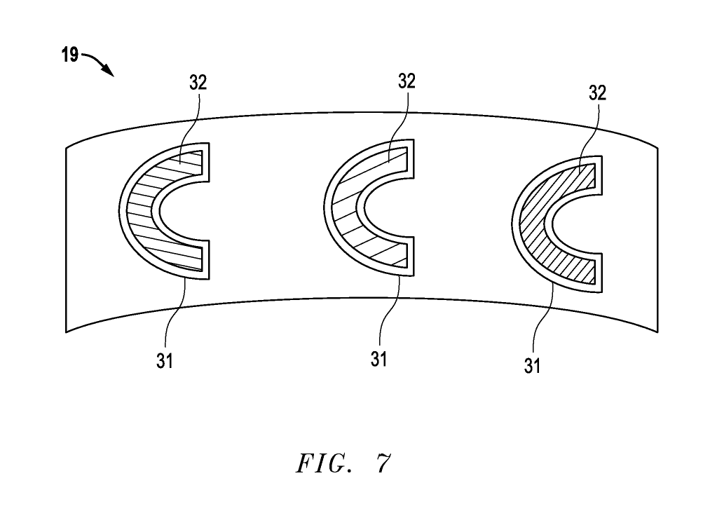

In the example of FIG. 7, the apertures 31 are filled with a material 32. The material may comprise, for example, one or more materials such as ceramic, rubber, plastic, non-abrasive materials or still other materials. These materials also may comprise one or more colors.

Embodiments of the abrasive portion 25 may overlay at least some of the plurality of apertures 31. For example, the abrasive portion 25 may overlay the apertures 31 in the at least one blade segment 19. In other examples, the abrasive portion 25 may overlay one or more apertures 31 without obstructing the one or more apertures 31. In other versions, the abrasive portion 25 may cover portions of the apertures 31. In still other examples, the abrasive portion 25 may overlie at least portions of the interior surfaces of the apertures 31 in the blade body 13.

In other embodiments, a method of using a rotary cutting blade 11 are disclosed. The method may comprise providing a blade body 13 with a plurality of blade segments 19, a cutting profile (e.g., a circumferential row 35) in each blade segment 19 at a radially outermost portion (e.g., perimeter edge 21) thereof, and a secondary profile (e.g., a circumferential row 39) located radially inward of the cutting profile 35 in respective interiors of the blade segments 19.

The method may further include using the rotary cutting blade 11 to cut a workpiece with the cutting profiles 35. The method may include wearing the cutting profiles 35 such they are worn and eroded, and exposing the secondary profiles 39 such that they become and are the radially outermost portion of the blade segments 19. In some embodiments, the secondary profiles 39 are substantially similar to the cutting profiles 35. The secondary profiles 39 may be substantially identical to the cutting profiles.

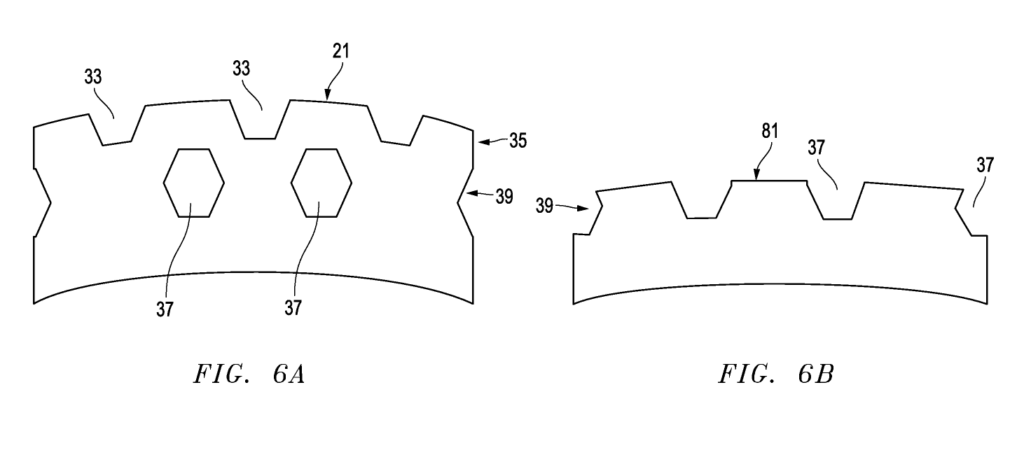

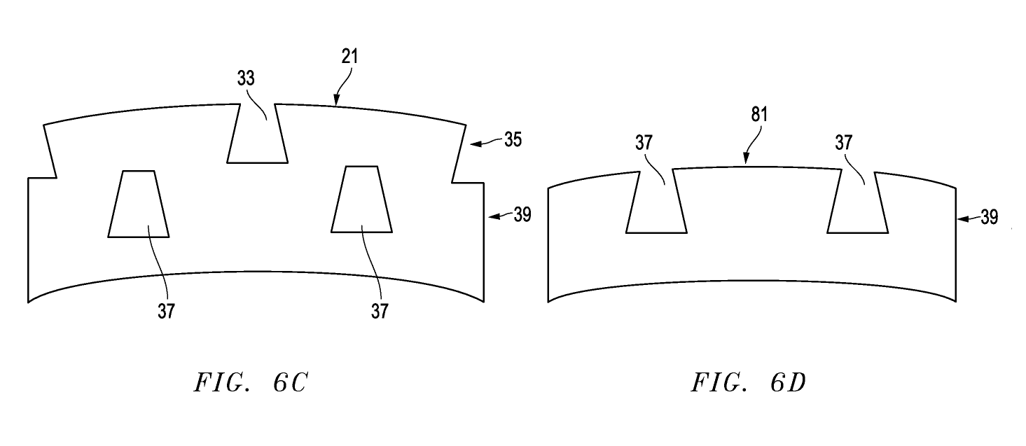

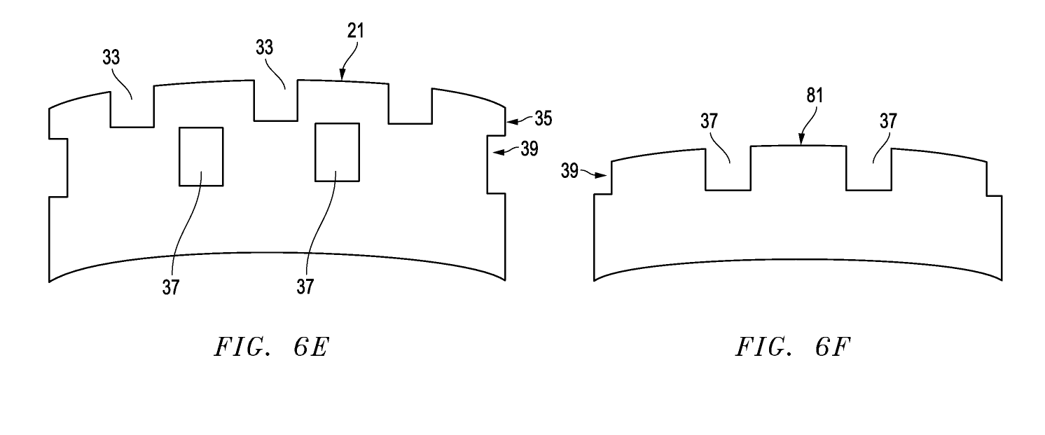

For example, FIG. 6A depicts a new or relatively new blade 11 with perimeter edge 21 and circumferential row 35. However, after the new blade 11 is worn (e.g., 50% worn), the blade is eroded to look like FIG. 6B, wherein circumferential row 39 is exposed and the radially outermost portion is edge 81. Similar examples are shown by comparing FIGS. 6C and 6D, as well as comparing FIGS. 6E and 6F. The method may include using the rotary cutting blade 11 to cut the workpiece with the secondary profiles 39.

Embodiments of the method may include providing one or more blade segments 19 with tertiary profiles (e.g., circumferential row 43 in FIG. 2) located radially inward of the secondary profiles 39 in respective interiors of the blade segments 19. The method may further comprise wearing the secondary profiles 39 such that they are worn and eroded, exposing the tertiary profiles 43 such that they become and are the radially outermost portion of the blade segments 19, and using the rotary cutting blade 11 to cut the workpiece with the tertiary profiles 43. Embodiments of the tertiary profiles 43 may be substantially similar or substantially identical to the cutting profiles and the secondary profiles.

During operation, embodiments of the apertures can improve material removal by abrasive as well as by mechanical shock. The apertures also can retain more lubricant to better control or reduce friction. In addition, the apertures can provide better ventilation and cooling management of the blade.

Embodiments of the cutting tool may comprise a blade or blade body formed from a base material such as steel. Some versions of the blade can have an outer diameter in a range of about 100 mm to about 3500 mm. The blade can have a thickness (e.g., without abrasive) in a range of about 1 mm to about 9 mm. The blade segments can have a circumferential length in a range of about 5 mm to about 60 mm. In some versions, the blade segments can have an axial thickness (e.g., blade and abrasive) in a range of about 1 mm to about 20 mm. Versions of the blade segments can have a radial height in a range of about 1 mm to about 30 mm. Other versions of the cutting tool can have a number of blade segments in a range of 2 to 200.

Embodiments can have slots between the blade segments. The slots can vary in size and shape. For example, the slots can have a narrowest circumferential gap or slot width of about 0.5 mm to about 5 mm. In other versions, the slots can have a widest circumferential gap or slot width of about 6 mm to about 40 mm. The abrasive can be joined to different portions of the blade. For example, measuring from the axial center of the blade, abrasive can be brazed onto the blade in a range of about 300 mm to about 3500 mm from the axial center. Similarly, abrasive can be laser welded onto the blade body in a range of about 80 mm to about 1200 mm from the axial center.

In addition, FIG. 2 depicts dimensions (in mm) of one exemplary embodiment. In that example, the dimensions may be used to define the relationships between the various apertures, rows and columns of a blade segment. These dimensions are merely one example, and are not intended to limit the embodiments described herein in any way. Other embodiments may include many other shapes, sizes and dimensions other than those shown in FIG. 2.

Embodiments also may comprise one or more of the following items.

Item 1. An abrasive article, comprising:
a blade body having an axis of rotation, a peripheral edge comprising a plurality of blade segments with perimeter edges, and wherein adjacent ones of the blade segments are separated from each other by a slot that extends into the blade body at least partially in a radial direction with respect to the axis;
at least one blade segment comprises a plurality of apertures extending axially therethrough, comprising a perimeter edge aperture that intersects the perimeter edge, and at least two interior apertures are radially offset from and do not intersect the perimeter edge; and
an abrasive portion comprising a bond material and abrasive particles, and the abrasive portion overlies at least portions of the blade segments.
   Item 2. The abrasive article of item 1, wherein the abrasive portion overlies all of the blade segments, and all of the blade segments comprise perimeter edge apertures and at least two interior apertures.
   Item 3. The abrasive article of item 1, wherein the plurality of apertures comprises a radial edge aperture formed in a radial edge of at least one of the blade segments, such that the radial edge aperture intersects a respective slot in the blade body.
   Item 4. The abrasive article of item 3, wherein all of the blade segments comprise at least one radial edge aperture.
   Item 5. The abrasive article of item 1, wherein the plurality of apertures comprise one or more shapes comprising polygons, curvilinear shapes or a combination thereof.
   Item 6. The abrasive article of item 1, wherein the plurality of apertures comprise a plurality of circumferential rows, and each row has at least two apertures.
   Item 7. The abrasive article of item 1, wherein the plurality of apertures comprise a plurality of radial columns, and each column has at least two apertures.
   Item 8. The abrasive article of item 1, wherein the plurality of apertures comprise a checkerboard pattern having a plurality of circumferential rows and a plurality of radial columns.
   Item 9. The abrasive article of item 1, wherein the plurality of apertures are formed in an array about the axis of rotation, and the array is symmetrical, asymmetrical, patterned, irregular or a plurality of arrays.
   Item 10. The abrasive article of item 1, wherein the abrasive portion is mounted to the blade body by at least one of adhesive bonding, brazing, laser welding and attachment by infiltration.
   Item 11. The abrasive article of item 1, wherein the bond material comprises a metallic powder and the abrasive particles comprise diamond.
   Item 12. The abrasive article of item 1, wherein the abrasive portion overlies at least some of the plurality of apertures.
   Item 13. The abrasive article of item 1, wherein the abrasive portion overlies the apertures in the at least one blade segment.
   Item 14. The abrasive article of item 1, wherein the abrasive article comprises a grinding wheel or a blade, and the blade body comprises a steel plate.
   Item 15. An abrasive article, comprising:
a blade body having an axis of rotation, a peripheral edge comprising a plurality of blade segments, and wherein adjacent ones of the blade segments are separated from each other by a slot that extends into the blade body at least partially in a radial direction with respect to the axis;
at least one of the blade segments comprises a radial edge aperture extending axially therethrough, and the radial edge aperture intersects a radial edge of the at least one of the blade segments, such that the radial edge aperture intersects a respective slot in the blade body; and
an abrasive portion comprising a bond material and abrasive particles, and the abrasive portion overlies at least portions of the blade segments.
   Item 16. The abrasive article of item 15, wherein the radial edge aperture is radially offset from and does not intersect a perimeter edge of the at least one of the blade segments.
   Item 17. The abrasive article of item 15, wherein at least one blade segment comprises a plurality of apertures extending axially therethrough, comprising a perimeter edge aperture that intersects the perimeter edge, and at least two interior apertures are radially offset from and do not intersect the perimeter edge.
   Item 18. The abrasive article of item 15, wherein the abrasive portion overlies all of the blade segments, and all of the blade segments comprise perimeter edge apertures and at least two interior apertures.
   Item 19. The abrasive article of item 15, wherein all of the blade segments comprise at least one radial edge aperture.
   Item 20. The abrasive article of item 15, wherein the plurality of apertures comprise one or more shapes comprising polygons, curvilinear shapes or a combination thereof.
   Item 21. The abrasive article of item 15, wherein the plurality of apertures comprise a plurality of circumferential rows, and each row has at least two apertures.
   Item 22. The abrasive article of item 15, wherein the plurality of apertures comprise a plurality of radial columns, and each column has at least two apertures.
   Item 23. The abrasive article of item 15, wherein the plurality of apertures comprise a checkerboard pattern having a plurality of circumferential rows and a plurality of radial columns.
   Item 24. The abrasive article of item 15, wherein the plurality of apertures are formed in an array about the axis of rotation, and the array is symmetrical, asymmetrical, patterned, irregular or a plurality of arrays.
   Item 25. The abrasive article of item 15, wherein the abrasive portion is mounted to the blade body by at least one of adhesive bonding, brazing, laser welding and attachment by infiltration.
   Item 26. The abrasive article of item 15, wherein the bond material comprises a metallic powder and the abrasive particles comprise diamond.
   Item 27. The abrasive article of item 15, wherein the abrasive portion overlies at least some of the plurality of apertures.
   Item 28. The abrasive article of item 15, wherein the abrasive portion overlies the apertures in the at least one blade segment.
   Item 29. The abrasive article of item 15, wherein the abrasive article comprises a grinding wheel or a blade, and the blade body comprises a steel plate.
   Item 30. A method of using a rotary cutting blade, comprising:
providing a blade body with a plurality of blade segments, a cutting profile having apertures in each blade segment at a radially outermost portion thereof, and a secondary profile having apertures located radially inward of the cutting profile in respective interiors of the blade segments;
using the rotary cutting blade to cut a workpiece with the cutting profiles;
wearing the cutting profiles such they are worn and eroded;
exposing the secondary profiles such that they are the radially outermost portion of the blade segments; and then
using the rotary cutting blade to cut the workpiece with the secondary profiles.
   Item 31. The method of item 30, wherein the secondary profiles are substantially similar to the cutting profiles.
   Item 32. The method of item 30, wherein each blade segment further comprises tertiary profiles having apertures located radially inward of the secondary profiles in respective interiors of the blade segments.
   Item 33. The method of item 32, further comprising wearing the secondary profiles such that they are worn and eroded, exposing the tertiary profiles such that they are the radially outermost portion of the blade segments, and using the rotary cutting blade to cut the workpiece with the tertiary profiles.
   Item 34. The method of item 32, wherein the tertiary profiles are substantially similar to the cutting profiles and the secondary profiles.
   Item 35. The method of item 32, wherein the tertiary profiles are substantially identical to the cutting profiles.
   Item 36. The method of item 32, wherein the cutting profile comprises a perimeter edge aperture that intersects the perimeter edge, and at least two interior apertures in the secondary profile are radially offset from and do not intersect the perimeter edge.
   Item 37. The method of item 36, wherein all of the blade segments comprise perimeter edge apertures and at least two interior apertures.
   Item 38. The method of item 32, further comprising an abrasive portion comprising a bond material and abrasive particles, the abrasive portion overlies at least portions of the blade segments.
   Item 39. The method of item 38, wherein the abrasive portion overlies all of the blade segments.
   Item 40. The method of item 32, wherein at least some of the blade segments comprise a radial edge aperture formed in a radial edge of at least one of the blade segments, such that the radial edge aperture intersects a slot in the blade body between adjacent ones of the blade segments.
   Item 41. The method of item 40, wherein all of the blade segments comprise at least one radial edge aperture.
   Item 42. The method of item 32, wherein the apertures have one or more shapes comprising polygons and curvilinear shapes.
   Item 43. The method of item 32, wherein the apertures comprise a plurality of circumferential rows, and each row has at least two apertures.
   Item 44. The method of item 32, wherein the apertures comprise a plurality of radial columns, and each column has at least two apertures.
   Item 45. The method of item 32, wherein the apertures comprise a checkerboard pattern having a plurality of circumferential rows and a plurality of radial columns.
   Item 46. The method of item 32, wherein the apertures are formed in an array about the axis of rotation, and the array is symmetrical, asymmetrical, patterned, irregular or a plurality of arrays.
   Item 47. The method of item 38, wherein the abrasive portion is mounted to the blade body by adhesive bonding, brazing, laser welding or attachment by infiltration.
   Item 48. The method of item 38, wherein the bond material comprises a metallic powder and the abrasive particles comprise diamond.
   Item 49. The method of item 38, wherein the abrasive portion overlies at least some of the apertures.
   Item 50. The method of item 38, wherein the abrasive portion overlies the apertures in the at least one blade segment.
   Item 51. The method of item 32, wherein the abrasive article comprises a grinding wheel or a blade, and a blade body comprising a steel plate.

This written description uses examples to disclose the embodiments, including the best mode, and also to enable those of ordinary skill in the art to make and use the invention. The patentable scope is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

Note that not all of the activities described above in the general description or the examples are required, that a portion of a specific activity may not be required, and that one or more further activities may be performed in addition to those described. Still further, the order in which activities are listed are not necessarily the order in which they are performed.

In the foregoing specification, the concepts have been described with reference to specific embodiments. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of invention.

As used herein, the terms “comprises,” “comprising,” “includes,” “including,” “has,” “having” or any other variation thereof, are intended to cover a non-exclusive inclusion. For example, a process, method, article, or apparatus that comprises a list of features is not necessarily limited only to those features but may include other features not expressly listed or inherent to such process, method, article, or apparatus. Further, unless expressly stated to the contrary, “or” refers to an inclusive-or and not to an exclusive-or. For example, a condition A or B is satisfied by any one of the following: A is true (or present) and B is false (or not present), A is false (or not present) and B is true (or present), and both A and B are true (or present).

Also, the use of “a” or “an” are employed to describe elements and components described herein. This is done merely for convenience and to give a general sense of the scope of the invention. This description should be read to include one or at least one and the singular also includes the plural unless it is obvious that it is meant otherwise.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims.

After reading the specification, skilled artisans will appreciate that certain features are, for clarity, described herein in the context of separate embodiments, may also be provided in combination in a single embodiment. Conversely, various features that are, for brevity, described in the context of a single embodiment, may also be provided separately or in any subcombination. Further, references to values stated in ranges include each and every value within that range.

What is claimed is:

1. An abrasive article, comprising:
a blade body having an axis of rotation, a peripheral edge comprising a plurality of blade segments with perimeter edges, and wherein adjacent ones of the blade segments are separated from each other by a slot that extends into the blade body at least partially in a radial direction with respect to the axis;
at least one blade segment comprises a plurality of apertures extending axially therethrough, comprising a perimeter edge aperture that intersects the perimeter edge, and at least two interior apertures are radially offset from and do not intersect the perimeter edge; and
an abrasive portion comprising a bond material and abrasive particles, and the abrasive portion overlies at least portions of the blade segments.

2. The abrasive article of claim 1, wherein the abrasive portion overlies all of the blade segments, and all of the blade segments comprise perimeter edge apertures and at least two interior apertures.

3. The abrasive article of claim 1, wherein the plurality of apertures comprises a radial edge aperture formed in a radial edge of at least one of the blade segments, such that the radial edge aperture intersects a respective slot in the blade body.

4. The abrasive article of claim 3, wherein all of the blade segments comprise at least one radial edge aperture.

5. The abrasive article of claim 1, wherein the plurality of apertures comprise one or more shapes comprising polygons, curvilinear shapes or a combination thereof.

6. The abrasive article of claim 1, wherein the plurality of apertures comprise a plurality of circumferential rows, and each row has at least two apertures.

7. The abrasive article of claim 1, wherein the plurality of apertures comprise a plurality of radial columns, and each column has at least two apertures.

8. An abrasive article, comprising:
a blade body having an axis of rotation, a peripheral edge comprising a plurality of blade segments, and wherein adjacent ones of the blade segments are separated from each other by a slot that extends into the blade body at least partially in a radial direction with respect to the axis;
at least one of the blade segments comprises a radial edge aperture extending axially therethrough, and the radial edge aperture intersects a radial edge of the at least one of the blade segments, such that the radial edge aperture intersects a respective slot in the blade body; and
an abrasive portion comprising a bond material and abrasive particles, and the abrasive portion overlies at least portions of the blade segments.

9. The abrasive article of claim 8, wherein the radial edge aperture is radially offset from and does not intersect a perimeter edge of the at least one of the blade segments.

10. The abrasive article of claim 8, wherein at least one blade segment comprises a plurality of apertures extending axially therethrough, comprising a perimeter edge aperture that intersects the perimeter edge, and at least two interior apertures are radially offset from and do not intersect the perimeter edge.

11. The abrasive article of claim 15, wherein the abrasive portion overlies all of the blade segments, and all of the blade segments comprise perimeter edge apertures and at least two interior apertures.

12. The abrasive article of claim 15, wherein all of the blade segments comprise at least one radial edge aperture.

13. The abrasive article of claim 15, wherein the plurality of apertures comprise a plurality of circumferential rows, and each row has at least two apertures.

14. The abrasive article of claim 15, wherein the plurality of apertures comprise a plurality of radial columns, and each column has at least two apertures.

15. A method of using a rotary cutting blade, comprising:
providing a blade body with a plurality of blade segments, a cutting profile having apertures in each blade segment at a radially outermost portion thereof, and a secondary profile having apertures located radially inward of the cutting profile in respective interiors of the blade segments;
using the rotary cutting blade to cut a workpiece with the cutting profiles;
wearing the cutting profiles such they are worn and eroded;
exposing the secondary profiles such that they are the radially outermost portion of the blade segments; and then
using the rotary cutting blade to cut the workpiece with the secondary profiles.

16. The method of claim 15, wherein the secondary profiles are substantially similar to the cutting profiles.

17. The method of claim 15, wherein each blade segment further comprises tertiary profiles having apertures located radially inward of the secondary profiles in respective interiors of the blade segments.

18. The method of claim 17, further comprising wearing the secondary profiles such that they are worn and eroded, exposing the tertiary profiles such that they are the radially outermost portion of the blade segments, and using the rotary cutting blade to cut the workpiece with the tertiary profiles.

19. The method of claim 17, wherein the tertiary profiles are substantially similar to the cutting profiles and the secondary profiles.

20. The method of claim 17, wherein the cutting profile comprises a perimeter edge aperture that intersects the perimeter edge, and at least two interior apertures in the secondary profile are radially offset from and do not intersect the perimeter edge.
